(19) United States
(12) Patent Application Publication
(10) Pub. No.: US 2003/0055587 A1
(43) Pub. Date: Mar. 20, 2003

(54) Rapid throughput surface topographical analysis

(75) Inventors: Youqi Wang, Atherton, CA (US); Qun Fan, Fremont, CA (US); C. Eric Ramberg, San Jose, CA (US); Earl Danielson, Palo Alto, CA (US); Damian A. Hajduk, San Jose, CA (US)

Correspondence Address: Scott A. Chapple, Dobrusin & Thennisch PC, Suite 311, 401 South Old Woodward Avenue, Birmingham, MI, 48009, US

(73) Assignee: Symyx Technologies, Inc., Santa Clara, CA (US)

(21) Appl. No.: 09/954,449

(22) Filed: Sep. 17, 2001

(51) Int. Cl. G06F 19/00

(52) U.S. Cl. 702/66

(57) ABSTRACT

A library of materials is screened for characteristics. Accordingly, a library of materials is provided and an electromagnetic wavefront is directed at each member of the library. The electromagnetic wavefront is monitored for a response after the wavefront encounters the at least for sample materials. Thereafter, the response of the electromagnetic wavefront is correlated to a characteristic of the at least four sample materials.

### TECHNICAL FIELD

The present invention generally relates to the field of materials characterization, and more specifically to the measurement of surface topography of materials.

### BACKGROUND OF THE INVENTION

Currently, there is substantial research activity directed toward the discovery and optimization of materials for a wide range of applications. Although the chemistry of reactions of various materials has been extensively studied, it is rarely possible to predict a priori the physical or chemical characteristics that a particular material will possess or the precise characteristics or parameters of the material that will result from any particular synthesis scheme. Thus, characterization techniques to determine such characteristics, parameters and the like are an essential part of the discovery process.

Combinatorial chemistry refers generally to methods for synthesizing a collection of chemically diverse materials and to methods for rapidly testing or screening this collection of materials for desirable performance characteristics and characteristics. Combinatorial chemistry approaches have greatly improved the efficiency of discovery of useful materials. For example, material scientists have developed and applied combinatorial chemistry approaches to discover a variety of novel materials, including for example, high temperature superconductors, magnetoresistors, phosphors and catalysts. See, for example, U.S. Pat. No. 5,776,359 to Schultz et al. In comparison to traditional materials science research, combinatorial materials research can effectively evaluate much larger numbers of diverse compounds in a much shorter period of time. Although such high-throughput synthesis and screening methodologies are conceptually promising, substantial technical challenges exist for application thereof to specific research and commercial goals.

The characterization of polymers or other materials using combinatorial methods has only recently become known. Examples of such technology are disclosed, for example, in commonly owned U.S. Pat. No. 6,182,499 (McFarland et al); U.S. Pat. No. 6,175,409 B1 (Nielsen et al); U.S. Pat. No. 6,157,449 (Hajduk et al); U.S. Pat. No. 6,151,123 (Nielsen); U.S. Pat. No. 6,034,775 (McFarland et al); U.S. Pat. No. 5,959,297 (Weinberg et al), all of which are hereby expressly incorporated by reference herein, for all purposes.

Of particular interest to the present invention are combinatorial methods and apparatuses for synthesizing or otherwise providing materials followed by screening of those materials for characteristics (e.g., properties, parameters etc.) such as volume, size, expandability, contractibility, phase change, density, elastic moduli, resistivity and the like. Synthesis and screening of the materials for such characteristics presents a multitude of challenges. As an example, measurements of volumes, densities and the like of materials can involve cumbersome equipment that is not amenable to rapid determination of characteristics of a plurality of samples. As another example, measurements and measurement conditions can be difficult to consistently repeat for a plurality of sample materials. Thus, the present invention has been designed to provide characterization methods and systems appropriate for combinatorial research of libraries of sample materials.

### SUMMARY OF THE INVENTION

In one non-limiting aspect of the present invention, there is provided a method for optically screening sample materials. According to the method a library of at least four sample materials is provided. An electromagnetic wavefront is directed at each of the at least four sample materials. A response of the electromagnetic wavefront is monitored after the wavefront encounters the at least four sample materials. Then, the response of the electromagnetic wavefront is correlated to one or more characteristics of the at least four sample materials.

### BRIEF DESCRIPTION OF THE DRAWINGS

FIG. 1 is a flowchart of steps for one method of the present invention.

FIG. 2 is a block diagram of one illustrative platform system for executing and operating methods and systems of the present invention.

FIG. 3 is a schematic of an exemplary system for optically screening a combinatorial library of sample materials.

FIG. 4 is a schematic of another exemplary system for optically screening a combinatorial library of sample materials.

FIG. 4(a) is a schematic of another exemplary system for optically screening a combinatorial library of sample materials.

FIG. 4(b) illustrates graphical representations of exemplary data acquired according to an aspect of the present invention.

FIGS. 5(a)-5(g) are illustrations of exemplary sample supports for characterization according to the present invention.

### DETAILED DESCRIPTION OF THE PREFERRED EMBODIMENT

Combinatorial Approaches for Science Research

In a combinatorial approach for identifying or optimizing materials or reactions, a large compositional space and/or a large reaction condition space (e.g., of temperature, pressure and reaction time) may be rapidly explored by preparing libraries and then rapidly screening such libraries. Combinatorial approaches for screening a library can include an initial, primary screening, in which several materials are rapidly evaluated to provide valuable preliminary data and, optimally, to identify several “hits”—particular candidate materials having characteristics that meet or exceed certain predetermined metrics (e.g., performance characteristics, desirable properties, unexpected and/or unusual properties, etc.). Such metrics may be defined, for example, by the characteristics of a known or standard material. Because local performance maxima may exist in compositional spaces between those evaluated in the primary screening of the first libraries or alternatively, in process-condition spaces different from those considered in the first screening, it may be advantageous to screen more focused libraries (e.g., libraries focused on a smaller range of compositions, or libraries comprising compounds having incrementally smaller structural variations relative to those of the identified hits) and additionally or alternatively, subject the initial hits to variations in process conditions. Hence, a primary screen can be used iteratively to explore localized and/or optimized compositional space in greater detail. The preparation and evaluation of more focused libraries can continue as long as the high-throughput primary screen can meaningfully distinguish among neighboring library compositions or compounds.

Once one or more hits have been satisfactorily identified based on the primary screening, materials libraries focused around the primary-screen hits can be evaluated with a secondary screen—a screen designed to provide (and typically verified, based on known materials, to provide) chemical composition or process conditions that relate with a greater degree of confidence to commercially-important processes and conditions than those applied in the primary screen. Particular samples that surpass the predetermined metrics for the secondary screen may then be considered to be “leads.” If desired, additional materials libraries focused about such lead materials can be screened with additional secondary screens or with tertiary screens. Identified lead materials, reaction conditions or the like may be subsequently developed for commercial applications through traditional bench-scale and/or pilot scale experiments.

While the concept of primary screens and secondary screens as outlined above provides a valuable combinatorial research model for investigating materials and materials reactions, a secondary screen may not be necessary for certain chemical processes where primary screens provide an adequate level of confidence as to scalability and/or where market conditions warrant a direct development approach. Similarly, where optimization of materials having known characteristics of interest is desired, it may be appropriate to start with a secondary screen. In general, the systems, devices and methods of the present invention may be applied as either a primary, secondary or other screen, depending on the specific research program and goals thereof. See, generally, U.S. patent application Ser. No. 09/227,558 entitled “Apparatus and Method of Research for Creating and Testing Novel Catalysts, Reactions and Polymers”, filed Jan. 8, 1999 by Turner et al., for further discussion of a combinatorial approach to polymer science research. Bulk quantities of a particular material may be made after a primary screen, a secondary screen, or both.

According to the present invention, methods, systems and devices are disclosed that improve the efficiency and/or effectiveness of the steps necessary to characterize parameters, properties, characteristics or a combination thereof for a material sample or a plurality of samples. In preferred embodiments, in the context of materials analysis, any of a plurality of material samples or of components thereof can be detected in a materials characterization system with an average sample-throughput sufficient for an effective combinatorial science research program.

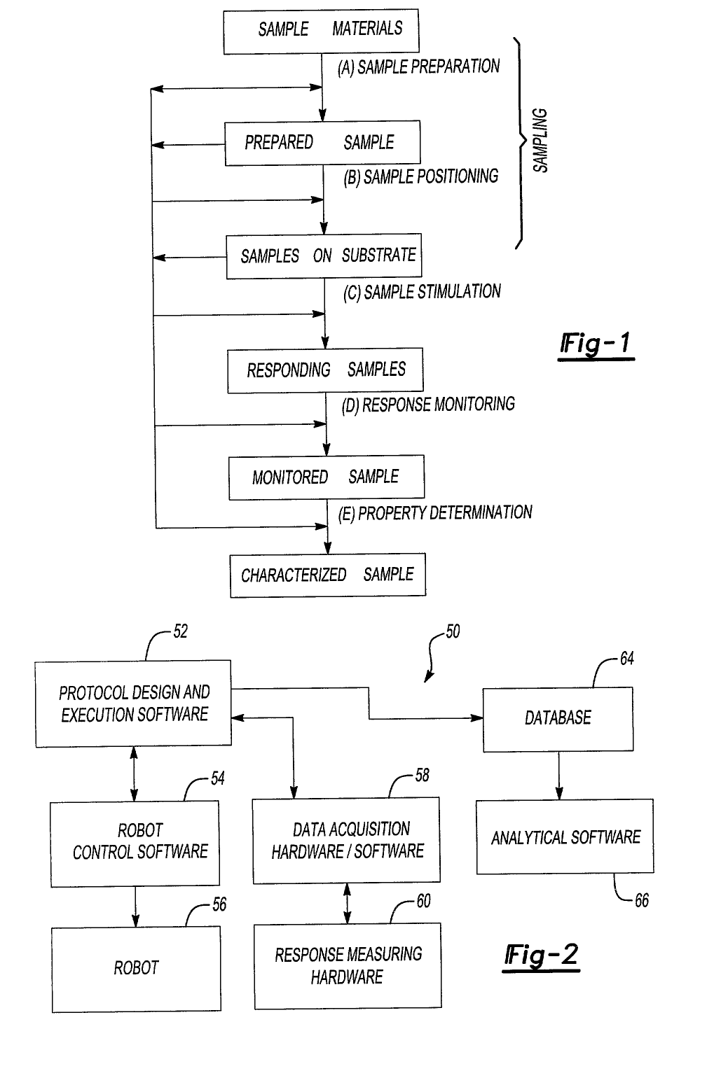

Referring to FIG. 1, the systems and methods, preferably, start with a library or array of sample materials that may exhibit one or more predetermined characteristics such as size, volume, density, topography, elastic moduli or the like. Ultimately, values for these predetermined characteristics may be established in a determination step (Step E), however, several steps may be effected prior to or during Step E. The sample materials may be prepared such as by heating, cooling, or addition of additives. Such preparation is typically designed to affect the characteristics that are ultimately being determined. The sample materials may also be positioned in a desirable manner for characteristic determination. The materials may be positioned on a substrate, a machine or otherwise positioned to assist in ultimately determining characteristics of the materials.

It will be appreciated that one of the advantageous features of the present invention is that it affords the ability to screen newly created materials some or all of which are uncharacterized or whose characteristics are unknown prior to the time of screening. Thus, previously unidentified and uncharacterized new materials can be screened for a common selected characteristic. However, this does not prevent the employment of known references controls or standard as among the library members.

It shall be recognized that sample preparation (Step A) and sample positioning (Step B) may be optional steps in characteristic determination protocols. Also sample preparation and sample positioning may be performed in any order if they are performed. Additionally it should be recognized that sequences other than the order of steps listed above are possible, and the above listing is not intended as limiting.

Typically, however, stimulation of the sample materials (Step C) is needed to effect one or more responses of the materials wherein the responses are related to the one or more characteristics that are being tested. Exemplary stimuli may include any form of electromagnetic radiation or other forms of stimulation. Exemplary responses include reflection, refraction, diffraction or the like.

The responses of the materials are typically monitored (Step D) with hardware such as detectors, sensors, transducers, monitors or other like devices. Such hardware will typically be coupled with a computer for controlling processing, acquiring data, compiling data, analyzing data or the like. Characteristics may be determined (Step E) quantitatively or qualitatively by relating the responses to the characteristics.

A plurality of samples may be characterized as described above in connection with FIG. 1. As a general approach for improving the sample throughput for sample materials, each of the steps (A) through (E) of FIG. 1 applicable to a given characterization protocol can be optimized with respect to time and quality of information, both individually and in combination with each other. Additionally or alternatively, each or some of such steps can be effected in a rapid-serial, parallel, serial-parallel or hybrid parallel-serial manner.

In preferred embodiments, characteristics such as unit volume, topology, density, expansion, contraction, layer thickness, phase characteristics (e.g., indicative of a phase change or crystal structure) or the like of a plurality of samples or of components thereof can be analyzed in a characterization system with an average sample-throughput sufficient for an effective combinatorial science research program.

The throughput of a plurality of samples through a single step in a characterization process is improved by optimizing the speed of that step, while maintaining—to the extent necessary—the information-quality aspects of that step. Although conventional research norms, developed in the context in which research was rate-limited primarily by the synthesis of samples, may find such an approach less than wholly satisfactory, the degree of rigor can be entirely satisfactory for a primary or a secondary screen of a combinatorial library of samples. For combinatorial research (and as well, for many on-line process control systems), the quality of information should be sufficiently rigorous to provide for scientifically acceptable distinctions among the compounds or process conditions being investigated, and for a secondary screen, to provide for scientifically acceptable correlation (e.g., values or, for some cases, trends) with more rigorous, albeit more laborious and time-consuming traditional characterization approaches.

The throughput of a plurality of samples through a series of steps, where such steps are repeated for the plurality of samples, can also be optimized. In one approach, one or more steps of the cycle can be compressed relative to traditional approaches or can have leading or lagging aspects truncated to allow other steps of the same cycle to occur sooner compared to the cycle with traditional approaches. In another approach, the earlier steps of a second cycle can be performed concurrently with the later steps of a first cycle. For example, in a rapid-serial approach for characterizing a sample, sample preparation, delivery to a substrate or the like, for a second sample in a series can be effected before or while the first sample in the series is being screened. As another example, a screen of a second sample in a series can be initiated while the first sample in the series is being screened.

A characterization protocol for a plurality of samples can involve a single-step process (e.g., direct measurement of a characteristic of a sample or of a component thereof) or several steps. In a rapid-serial screen approach for a single-step process, the plurality of samples and a single measuring instrument or other instruments are serially positioned in relation to each other for serial analysis of the samples. In a parallel analysis approach, (e.g., as might be employed by itself, or in an upstream or downstream analysis of the samples relative to a rapid-serial analysis of the present invention) two or more measuring instruments or other apparatuses are employed to measure characteristics of two or more samples simultaneously.

In a serial-parallel approach, a characteristic of a larger number of samples (e.g., four or more) is screened as follows. First, a characteristic of a subset of the four or more samples (e.g., 2 samples) is screened in parallel for the subset of samples, and then serially thereafter, a characteristic of another subset of four or more samples is screened in parallel. It will be recognized, of course, that plural measuring instruments can be employed simultaneous, or plural measuring instruments can be employed serially.

For characterization protocols involving more than one step, optimization approaches to effect high-throughput characterization can vary. As one example, a plurality of samples can be characterized with a single characterization system (I) in a rapid-serial approach in which each of the plurality of samples (s₁, s₂, s₃ . . . sₙ) are processed serially through the characterization system (I) with each of the steps effected in series on each of the of samples to produce a serial stream of corresponding characterizing characteristic information (p₁, p₂, p₃ . . . pₙ). This approach benefits from minimal capital investment, and may provide sufficient throughput—particularly when the steps have been optimized with respect to speed and quality of information.

As another example, a plurality of samples can be characterized with two or more instruments in a pure parallel (or for larger libraries, serial-parallel) approach in which the plurality of samples (s₁, s₂, s₃ . . . sₙ) or a subset thereof are processed through the two or more measurement systems (I, II, III . . . N) in parallel, with each individual system effecting each step on one of the samples to produce the characteristic information (p₁, p₂, p₃ . . . pₙ) in parallel. This approach is advantageous with respect to overall throughput, but may be constrained by the required capital investment.

In a hybrid approach, certain of the steps of the characterization process can be effected in parallel, while certain other steps can be effected in series. Preferably, for example, it may be desirable to effect the longer, throughput-limiting steps in parallel for the plurality of samples, while effecting the faster, less limiting steps in series. Such a parallel-series hybrid approach can be exemplified by parallel sample preparation of a plurality of samples (s₁, s₂, s₃ . . . sₙ), followed by measuring with a single apparatus to produce a serial stream of corresponding characterizing information (p₁, p₂, p₃ . . . pₙ). In another exemplary parallel-series hybrid approach, a plurality of samples (s₁, s₂, s₃ . . . sₙ) are prepared, measured and correlated in a slightly offset (staggered) parallel manner to produce the characterizing information (p₁, p₂, p₃ . . . pₙ) in the same staggered-parallel manner.

Optimization of individual characterization steps with respect to speed and quality of information can improve sample throughput regardless of whether the overall characterization scheme involves a rapid-serial or parallel aspect (i.e., true parallel, serial-parallel or hybrid parallel-series approaches). As such, the optimization techniques disclosed hereinafter, while discussed primarily in the context of a rapid-serial approach, are not limited to such an approach, and will have application to schemes involving parallel characterization protocols that may be employed.

Sample Size

The sample size is not narrowly critical, and can generally vary, depending on the particular characterization protocols and systems used to analyze the sample or components thereof. However, it will be appreciated that the present invention advantageously permits for attaining reliable data with relatively small samples, thus permitting the rapid gathering of useful data from miniaturized analytical systems. Sample sizes might range from about 0.1 microgram to about 500 grams or from about 1 microgram to about 100 milligrams or from about 5 micrograms to about 1000 micrograms or from about 20 micrograms to about 50 micrograms. Larger or smaller sample sizes are also possible.

If and when placed on a substrate for forming a library, as discussed herein with regard to sampling, the samples may be dispensed with any suitable solid, liquid, or vapor dispensing or deposition apparatus (e.g. an automated micropipette or capillary dispenser, possibly with a heated tip). Each sample of the library is dispensed to an individually addressable region on the substrate. Preferably each sample occupies no more than about 1000 mm² of area on a substrate surface, more preferably no more than about 100 mm², and even more preferably no more than about 10 mm². In applications where the sample is disposed in a well, preferably the sample size does not exceed about 1000 milligrams.

Accordingly, for dispensing fluid samples, the individual samples are each dispensed in amounts no greater than about 100 ml, more preferably no greater than about 10 ml and still more preferably no greater than about 1 ml. Average sample thicknesses may range from about 1 micron or smaller, more preferably less than about 10 microns, more preferably less than 100 microns, still more preferably less than about 1 mm. Larger sample sizes are also possible.

Libraries of Sample Materials

Another advantage of the present invention is that it permits for the analysis of many different samples, including those carried on a common substrate, those not carried on a common substrate, or the both. The resulting collection of materials thus will comprise a library of samples. Thus, typically, libraries of samples have 2 or more samples that are physically or temporally separated from each other—for example, by residing in different regions of a common substrate, in different sample containers of a common substrate, by having a membrane or other partitioning material positioned between samples, or otherwise. The plurality of samples preferably has at least 4 samples and more at least 8 samples. Four samples can be employed, for example, in connection with experiments having one control sample and three other samples varying (e.g., with respect to composition or process conditions as discussed above) to be representative of a high, a medium and a low-value of the varied factor—and thereby, to provide some indication as to trends. Four samples are also a minimum number of samples to effect a serial-parallel characterization approach, as described above (e.g., with two analytical instruments operating in parallel). Higher numbers of samples can be investigated, according to the methods of the invention, to provide additional insights into larger compositional and/or process space. In some cases, for example, the plurality of samples can be 15 or more samples, preferably 20 or more samples, more preferably 40 or more samples and even more preferably 80 or more samples. Such numbers can be loosely associated with standard configurations of other parallel reactor configurations for synthesizing materials for screening herein (e.g., the PPR-48™, Symyx Technologies, Inc.) or of standard sample containers (e.g., 96-well microtiter plate-type formats). Moreover, even larger numbers of samples can be characterized according to the methods of the present invention for larger scale research endeavors. Hence, for screening of materials the number of samples can be 150 or more, 400 or more, 500 or more, 750 or more, 1,000 or more, 1,500 or more, 2,000 or more, 5,000 or more and 10,000 or more samples.

In some cases, in which processing of samples might use 96-well microtiter-plate formatting or scaling, the number of samples can be 96*N, where N is an integer ranging from about 1 to about 100 or greater. For many applications, N can suitably range from 1 to about 20, and in some cases, from 1 to about 5. In thin film applications, any number of samples may be placed upon a wafer. For example, up to 25,000 samples or greater may be placed on a wafer.

A library of samples comprises two or more different samples spatially separated—preferably, but not necessarily on a common substrate, or temporally separated. Candidate samples (i.e., members) within a library may differ in a definable and typically predefined way, including with regard to chemical structure, processing (e.g., synthesis) history, mixtures of interacting components, post-synthesis treatment, purity, etc. The samples are spatially separated, preferably at an exposed surface of the substrate, such that the library of samples is separately addressable for characterization thereof. The two or more different samples can reside in sample containers formed as wells in a surface of the substrate. The number of samples included within the library can generally be the same as the number of samples included within the plurality of samples, as discussed above. In general, however, not all of the samples within a library of samples need to be different samples. When process conditions are to be evaluated, the libraries may contain only one type of sample. The use of reference standards, controls or calibration standards may also be performed, though it is not necessary. Further, a library may be defined to include sub-groups of members of different libraries, or it may include combinations of plural libraries.

Typically, however, for combinatorial science research applications at least four or more, eight or more and, in many cases, most preferably each of the plurality of samples in a given library of samples will be different from each other. Specifically, a different sample can be included within at least about 50%, preferably at least 75%, preferably at least 80%, even more preferably at least 90%, still more preferably at least 95%, yet more preferably at least 98% and most preferably at least 99% of the samples included in the sample library. In some cases, all of the samples in a library of samples will be different from each other.

In one embodiment, preferably at least eight samples are provided in a library on a substrate and at least about 50% of the samples included in the library are different from each other. More preferably, the library includes at least 16 samples and at least 75% of said samples included in said library are different from each other. Still more preferably, the library includes at least 48 samples and at least 90% of said samples included in the library are different from each other.

The substrate can be a structure having a rigid or semi-rigid surface on which or into which the library of samples can be formed, mounted, deposited or otherwise positioned. The substrate can be of any suitable material, and preferably includes materials that are inert with respect to the samples of interest, or otherwise will not materially affect the mechanical or physical characteristics of one sample in a library relative to another. Organic and inorganic polymers may also be suitably employed in some applications of the invention. Exemplary polymeric materials that can be suitable as a substrate material in particular applications include polyimides such as Kapton™., polypropylene, polytetrafluoroethylene (PTFE) and/or polyether etherketone (PEEK), among others. The substrate material is also preferably selected for suitability in connection with known fabrication techniques. Metal or ceramic (e.g., stainless steel, silicon, including polycrystalline silicon, single-crystal silicon, sputtered silicon, and silica (SiO₂) in any of its forms (quartz, glass, etc.)) are also preferred substrate materials. Other known materials (e.g., silicon nitride, silicon carbide, metal oxides (e.g., alumina), mixed metal oxides, metal halides (e.g., magnesium chloride), minerals, zeolites, and ceramics) may also be suitable for a substrate material in some applications. As to form, the sample containers formed in, at or on a substrate can be preferably, but are not necessarily, arranged in a substantially flat, substantially planar surface of the substrate. The sample containers can be formed in a surface of the substrate as dimples, spots, wells, raised regions, trenches, or the like. Non-conventional substrate-based sample containers, such as relatively flat surfaces having surface-modified regions (e.g., selectively wettable regions) can also be employed. The overall size and/or shape of the substrate is not limiting to the invention. The size and shape can be chosen, however, to be compatible with commercial availability, existing fabrication techniques, and/or with known or later-developed automation techniques, including automated sampling and automated substrate-handling devices. The substrate is also preferably sized to be portable by humans. The substrate can be thermally insulated, particularly for high-temperature and/or low-temperature applications.

Analytical Systems and Methods

According to the present invention, one or more systems, methods or both are used to determine the characteristics of a plurality of sample materials. Though manual or semi-automated systems and methods are possible, preferably an automated system or method is employed. A variety of robotic or automatic systems are available for automatically or programmably providing predetermined motions for handling, contacting, dispensing, or otherwise manipulating materials in solid, fluid, liquid or gas form according to a predetermined protocol. Such systems may be adapted or augmented to include a variety of hardware, software or both to assist the systems in determining characteristics of materials. Hardware and software for augmenting the robotic systems may include, but are not limited to, sensors, transducers, data acquisition and manipulation hardware, data acquisition and manipulation software and the like. Exemplary robotic systems are commercially available from CAVRO Scientific Instruments (e.g., Model NO. RSP9652) or BioDot (Microdrop Model 3000).

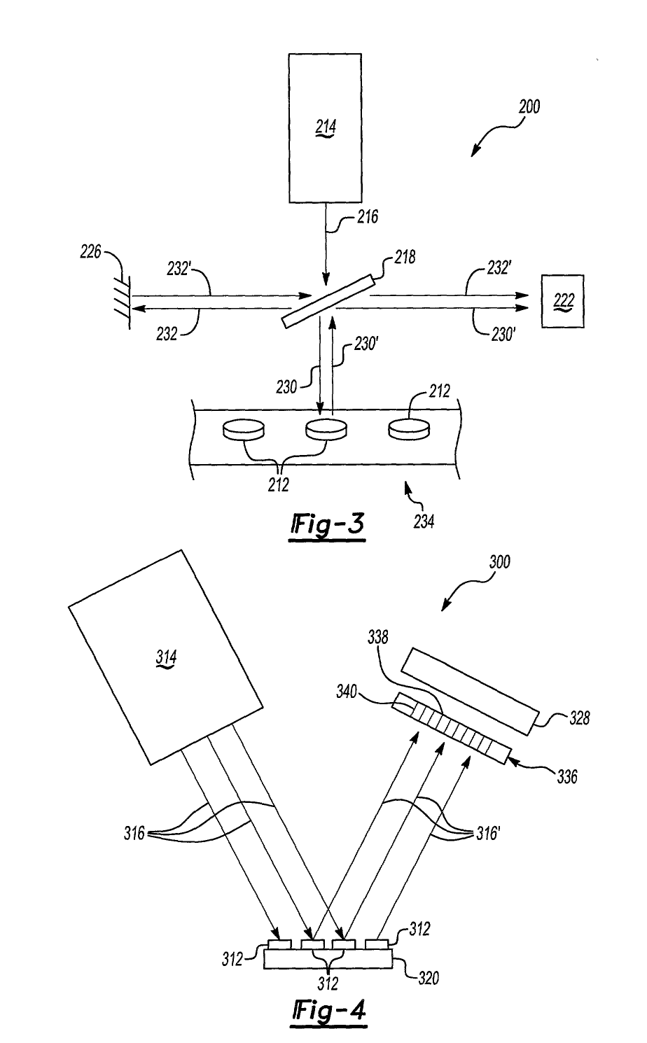

Referring to FIG. 2, there is a schematic diagram of an exemplary automated system 50 for rapid determination of topography characteristics of plural samples of material. Generally, the system 50 includes a suitable protocol design and execution software 52 that can be programmed with information such as synthesis, composition, location information or other information related to a library of materials or its members positioned with respect to a substrate. The protocol design and execution software is typically in communication with instrument control software 54 for controlling a robot 56 or other automated apparatus or system. The protocol design and execution software 52 is also in communication with data acquisition hardware/software 58 for collecting data from response measuring hardware 60. The instrument control software 54 may command a wavefront source 56 to direct a wavefront toward a sample. Measurement hardware 60 (e.g., detectors, sensors, transducers, load cells or the like) monitors the wavefront and provides data on the responses to the data acquisition hardware/software 58. Thereafter, the instrument control software 54, the data acquisition hardware/software 58 or both transmit data to the protocol design and execution software 52 such that the sample materials or information about the sample materials may be matched with wavefront response and transmitted to a database 64. Once the data is collected in the database, analytical software 66 may be used to analyze the data, and more specifically, to determine mechanical characteristics of the sample materials, or the data may be analyzed manually.

In a preferred embodiment, the system is driven by suitable software, such as LIBRARY STUDIO™, by Symyx Technologies, Inc. (Santa Clara, Calif.); IMPRESSIONIST™, by Symyx Technologies, Inc. (Santa Clara, Calif.); EPOCH™, by Symyx Technologies, Inc. (Santa Clara, Calif.) or a combination thereof. Moreover, data collected or produced by the system may be viewed using other suitable software such as POLYVIEW™, by Symyx Technologies, Inc. (Santa Clara, Calif.). The skilled artisan will appreciate that the above-listed software can be adapted for use in the present invention, taking into account the disclosures set forth in commonly-owned and copending U.S. patent application Ser. No. 09/174,856 filed on Oct. 19, 1998, U.S. patent application Ser. No. 09/305,830 filed on May 5, 1999 and WO 00/67086, U.S. application Ser. No. 09/420,334 filed on Oct. 18, 1999, U.S. application Ser. No. 09/550,549 filed on Apr. 14, 2000, each of which is hereby incorporated by reference. Additionally, the system may also use a database system developed by Symyx Technologies, Inc. to store and retrieve data with the overlays such as those disclosed in commonly-owned and copending U.S. patent application Ser. No. 09/755,623 filed on Jan. 5, 2001, which is hereby incorporated by reference for all purposes. The software preferably provides graphical user interfaces to permit users to design libraries of materials by permitting the input of data concerning the precise location on a substrate of a material (i.e., the address of the material). Upon entry, the software will execute commands to control movement of the robot, for controlling activity at such individual address.

Many of such aspects of the invention can be directly translated for use with parallel, serial or serial-parallel protocols. In a preferred embodiment, for example, a rapid serial force system and protocols for that system can be used for characterization of materials with very high sample throughput.

Optical Measurements of Characteristics of Sample Material

Generally speaking, optically measuring characteristics of a plurality of sample materials that compose a combinatorial library include the following steps; 1) directing an electromagnetic wavefront toward the plurality of samples materials, 2) monitoring the wavefront response to its encounter with the plurality of sample materials and 3) correlating the response of the wavefront to a characteristic such as unit volume, topography, density, expansion, contraction, layer thickness, phase characteristics (e.g., indicative of a phase change or crystal structure) or the like of a plurality of samples or of components thereof.

The electromagnetic wavefront may be any measurable wavefront such as a wavefront derived from one or more radiation sources, such as radio waves, microwaves, infrared light, visible light, ultraviolet light, X-rays, gamma rays or the like. In a particularly preferred embodiment, the wavefront is from light, more preferably a narrow bandwidth wavelength, and still more preferably a single wavelength monotonic light, such as that obtainable from as a laser beam. Any suitable laser may be employed, including for instance doped insulator lasers (e.g., a yttrium aluminum garnet (YAG) laser), a gas laser (e.g., helium neon (HeNe)), gas ion laser, carbon dioxide laser), a diode laser, or the like. The wavefront source may be any suitable source, and may include a collimated fiber coupled with a source or derive from a fiber optic point source.

Preferably, the wavefront source is controllable for allowing continuous or intermittent and targeted release of radiation relative to the samples being analyzed. The light may be simultaneously directed at one or more entire libraries of sample materials, at sets of sample materials within a library, at single samples individually, or even at preselected regions within a particular sample or a combination thereof.

Preferably the sample materials are positioned in direct opposing relation to the wavefront source. A suitable stationary or translatable holder holds the samples or any substrate into or onto which the samples are deposited.

A suitable wavefront monitor is employed downstream from the path of any wavefront emitted by the wavefront source. Downstream may encompass, but is not limited to, positioning the monitor for detection of a reflected, diffracted or refracted wavefront. Thus, the monitor may even be adjacent the wavefront source.

Any of a number of different types of wavefront monitors may be employed, including but not limited to an interferometer, a beam profiler, or an art-disclosed wavefront sensor. In one preferred embodiment, the wavefront monitor uses a Shack-Hartmann technique or an art-disclosed modification thereof to geometrically measure optical wavefronts. The wavefront monitor preferably employs a charge coupled device (CCD) or a like type of camera device (e.g., an infrared detector for use with an infrared wavefront) for sensing the wavefront. An aperture lens (e.g., microlens), an array of apertures or lenses, another suitable optic, or a combination thereof, typically is located in advance of the camera device. The incoming wavefront is sampled by the lens system (e.g. a microlens array) into a number of spots. The spot positions are analyzable relative to a reference wavefront, and thereby provide information about which aberrations are present. In a preferred embodiment, the camera device is coupled with a computer for acquiring data and storing it and optionally for real time data output.

It is thus appreciated that such a system allows for determinations to be made pertaining to the nature and amounts of a wavefront absorbed, reflected, diffracted, refracted or otherwise by one or more sample material or a surface thereof.

To allow light to be directed at sample materials for monitoring, it may be necessary to move the sample materials, the light sources, the light monitors or a combination thereof relative to each other. Accordingly, any of the sample holder, the wavefront monitor or the wavefront source may be translatable, such as by a robot or other suitable automated system. Moreover, the wavefront monitor, the sample holder and the wavefront source may be a part of an integrated instrument, or it may be comprised of separate units.

The systems of the present invention are employed to gather data about the topography of a sample. Alternatively, they are employed to gather data about the topography of a plurality of different samples disposed on a common substrate. They may also be employed to gather data about micro-quantities of each of a plurality of different samples disposed on a common substrate. Of course, the present invention also permits for the analysis of different regions of a single sample, e.g., a sample disposed on a substrate.

In general, therefore, the system of the present invention affords the determination of relative or absolute distances of the surface of a sample relative to a predetermined reference location, which in some embodiments may be the wavefront source, the wavefront monitor or a combination thereof. This resolution can be very accurate (e.g., on the order of 1 nanometer or less)

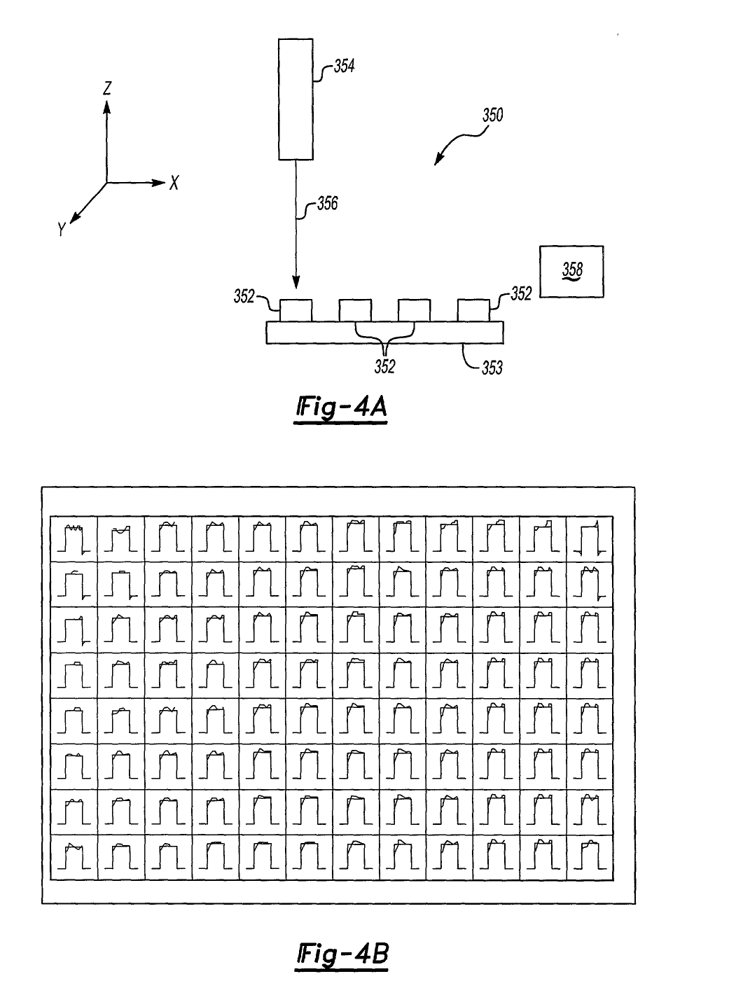

Referring to FIG. 3, there is illustrated an interferometer based system 200 for determining the surface topography of a plurality of sample materials 212 disposed upon a common substrate. As can be seen, the system 200 includes a wavefront source 214 for directing monotonic light 216 at the sample materials 212. The system 200 also includes an optic 218 (e.g., a partial mirror), a wavefront monitor 222, and a reference optical reflector 226 (e.g., a reference mirror).

In the embodiment shown, the wavefront source 214 directs light 216 at a partial mirror 218, which splits the light 216 into a sample beam 230 directed toward the sample 212 and a reference beam 232 directed at the reference mirror 226. A reflected reference beam 232′ is reflected by the reference mirror 226 and a reflected sample beam 230′ is reflected from the sample 212 back toward or through the partial mirror 218. The reflected beams 230′ and 232′ are thus transmitted to the wavefront monitor 222. The wavefront monitor 222 determines the phase shift difference between the reflected sample beam 230′ from the sample material 212 and the reflected reference 232′ from the reference reflector 226. Using information about the spacing of the components of the system relative to each other and to the sample, the phase shift difference is then correlated with a topography of the sample. It will be appreciated that the above can be repeated consecutively for a plurality of different samples on the substrate in rapid serial format. For example, a sample holder 234 may be comprise a manual or automated x-y translation stage. Alternatively, it may be possible to employ plural wavefront sources, monitors or both for simultaneous analysis of a plurality of samples.

In an another embodiment, the partial mirror 218 may be an optical element that, in addition to having the ability to direct light 216, also has the ability to spread light 216 out such that the light 216 may be directed at more than one sample material 212 at a time or can be directed at an entire library of sample materials 212. In that case, the light monitor 222 is preferably a CCD camera with the ability to create an image (e.g., a two dimensional image) of the topography of the library of the sample materials 212.

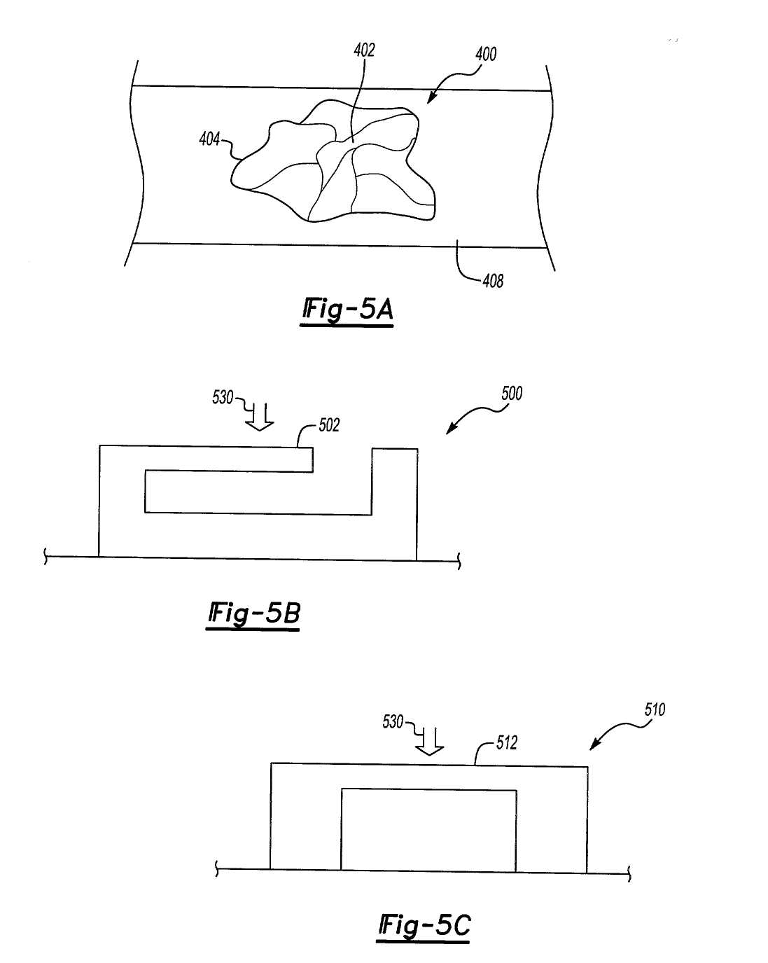

According to another preferred embodiment, a wave-front monitor may be used to direct light at the sample materials or to monitor light that has been directed at the sample materials or both. Referring to FIG. 4, there is illustrated a wave-front analyzer system 300 for determining the surface topography of a combinatorial library of sample materials 312. As can be seen, the system 300 includes a light source 314 for directing light 316 at sample materials 312, and a light sensor 328 for receiving light 316′ reflected from the sample materials 312. The sample materials 312 are illustrated as supported by a single common substrate 320. (Of course, as with the other embodiments herein, it will be appreciated that plural substrates may be employed on a common substrate holder).

The light source 314 may be a laser that emits a sample beam 316 toward at least one of the sample materials 312, and preferably toward an entire library of samples materials 312 simultaneously. Optionally, a lens (not shown) may be positioned intermediate the light source 314 and the sample materials 312 for broadening or focusing the sample beam 316 before it reaches the sample materials 312.

The sample beam 316 reflects off of at least one surface of the sample materials 312 and is redirected toward the light sensor 328. The light sensor 328 may then receive a reflected sample beam 316′ (corresponding to each of the respective samples) at various times, depending upon the differences in topography of each of the respective sample materials 312. For instance, a shorter time between two samples, all else equal, would denote a difference in the length of the path traveled by the beams, which would correspond with a difference in relative surface heights. The light sensor 328 is coupled with a computer into which readings are inputted at various time intervals. The relative phase differences of the respective beams over time can then be correlated with surface topography.

In a preferred embodiment, the system 300 includes a light refocusing subsystem 336. In the embodiment shown, the refocusing subsystem 336 is a substrate 338 having a plurality (e.g., an array of at least about 50, more preferably at least about 100, or as high as 1000 or more) of lenses 340 disposed in through-holes of the substrate. The through-holes and the lenses 340 are configured to allow only a portion of the reflected sample beam 316′ to pass through the lenses 340, the through-holes or both. Preferably the portion of reflected sample beam 316′ that passes through the through-holes is all traveling in substantially in a single direction relative to the light monitor 328, and even more preferably, the single direction is substantially parallel to a direction that the through-holes extend through the substrate 338. In this manner, the only difference in distances traveled by the portion of reflected light 316 that actually reaches the light monitor 328 and that actually reflect off of one of the sample materials 312 is brought about by differences in topography of the sample materials 312.

According to another preferred embodiment, a displacement meter may be used to monitor light that has been directed at the sample materials. Referring to FIG. 4(a), there is illustrated a displacement meter based system 350 for determining the surface topography of a combinatorial library of sample materials 352 provided on a substrate 353. The system 350 includes a light source 354 (e.g. a laser) for directing light 356 at sample materials 352, and a light sensor 358 for sensing light that encounters the sample materials 352.

The light sensor 358 is a laser displacement meter, which may be a confocual laser displacement meter. The displacement meter may include or be connected to a controller (e.g., a computer or other controller) and a camera unit (for visual viewing of measurements, if desired). Such meters are commercially available, such as sensor head model no. LT-8110 coupled with controller LT-8105 and camera unit LT-V201 available from the Keyence Corporation of America (Woodcliff Lake, N.J.).

In operation, the light source 354, the sample materials 352, the substrate 353, the meter 358 or a combination thereof are moveable relative to each other for directing light 356 at the sample materials 352 according to a pattern. As the light 356 encounters the sample materials 352, the meter 358 obtains a cross-section of the height or distance of the sample materials 352 relative to the substrate 353. Any number of cross-sections may be obtained to determine topography of the sample materials 352 and the greater the number of cross-sections, typically, the greater the accuracy of the determination of the topography.

Exemplary graphical representations of cross-sections of sample materials are shown in FIG. 4(b) with dotted lines. Also shown in solid lines are graphical representations of averages of the cross-sections that may be figured using one or more mathematical algorithms. Such averages may be useful for measurements of characteristics such as average height or average volumes where less accuracy is desired for one or more combinatorial screens.

Once determined, the topography of the sample materials of a combinatorial library may be used to assist in determining the volume of the sample materials. To determine volume, the topography of one or more surfaces of the sample materials may be used along with other known, determined or predetermined dimensions of the sample materials.

As an example, the topography of a surface of a sample material may be determined as outlined above as a function of the distance that the surface is from a reference location. Moreover, the outer periphery of that surface may also be determined. Preferably, the outer periphery of the surface also defines the outer periphery of the sample material and, moreover, the surface for which the topography has been determined is preferably opposite a surface of known topography (e.g., a flat surface defined on a substrate, with which the sample material is in contact). A plurality of data points may be taken from different locations on the surface, or a wide beam used to collect an overall surface view. Surface contours can be modeled using art-disclosed algorithms, or otherwise mathematically integrated. With knowledge of the dimension of the outer periphery, and the flat surface adjoining the substrate, and the relative heights over the surface, volume can be mathematically determined. Knowledge of the volume of a sample is useful for determining a host of other properties, such as density, thermal response characteristics (e.g., expansion or contraction), or the like.

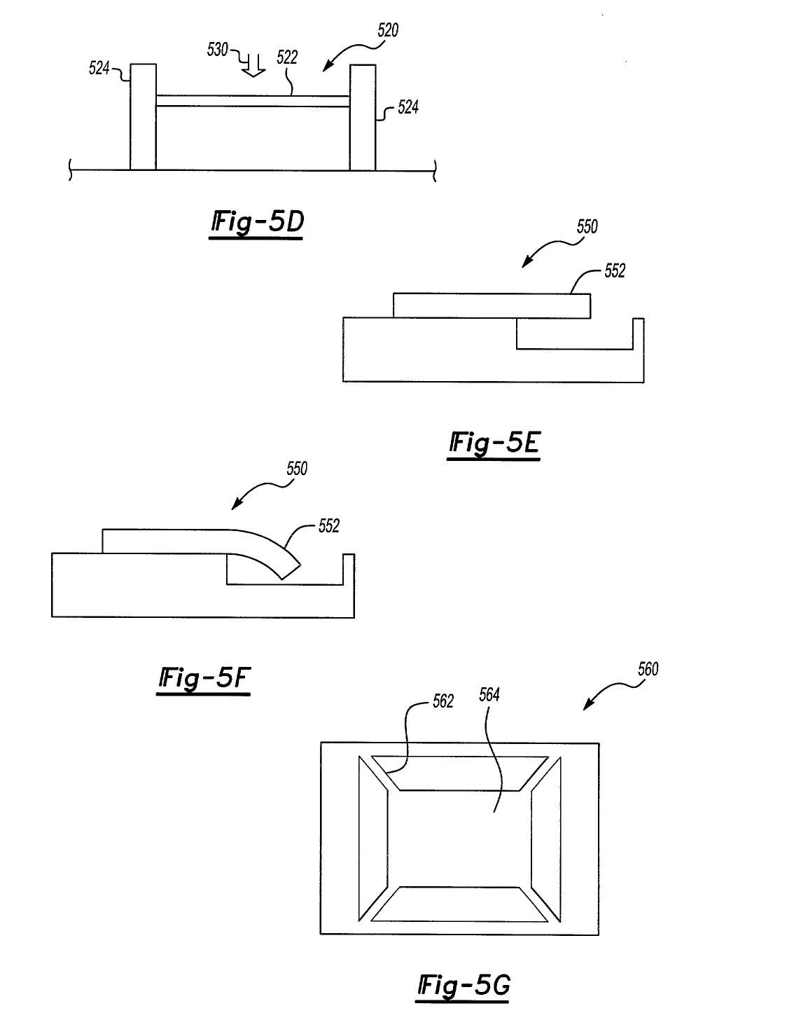

According to one preferred embodiment and with reference to FIG. 5(a), there is illustrated a sample material 400 with an irregular or substantially non-planar surface 402. The sample material 402 also includes an outer periphery 404. Preferably the topography of the surface 402 is known as function of the distance that the surface 402 is away from a substrate 408 upon which the sample material 400 is supported or another reference location. To determine the volume of the sample material 400, the function that represent the topography of the surface 402 is integrated over the entire area that is within the outer periphery 404.

It shall be recognized that a variety of computer software is available to perform complex analysis of the topography of surfaces. For example, Lucent Technologies has offered software for one and two dimensional surface analysis under the name TOPO. Another example of suitable software adaptable for two or three dimensional analysis is Solar Map Universal, form UBM, USA. Viewer software may also be employed of the type such as MS MacroSystem 3D Beam View Software.

The present invention may be used to acquire both static and dynamic information for characterizing sample materials of a plurality of samples, such as samples within one or more combinatorial libraries. In various instances the topography and other dimensions of sample materials in a combinatorial library can change over time. For example, sample materials can expand, contract, oscillate, deteriorate, grow, vibrate or otherwise move or alter condition or size. Accordingly, topography measurements or other measurements of each of the sample materials of a combinatorial library may be repeatedly performed at various intervals of time to monitor changes of the sample materials.

In one embodiment, the present invention may be employed for measuring characteristics such as thickness, volume and the like of one or more layers of material during or after the material is synthesized or deposited upon a substrate. The material may be formed as a film or other layer and may be formed according to a variety of techniques. For example, films may be formed by vapor deposition, evaporation deposition, chemical reaction or other such techniques. Once the characteristics (e.g., thickness, volume) of the layers have been measured, the characteristics may be correlated to other characteristics or parameters such as the efficacy of reaction parameters such as starting materials, reaction conditions and the like or the efficacy of deposition or other forming techniques. Exemplary films may range from about 1 angstrom to about 1 centimeter or from about 1 micron to about 3 millimeters or from about 0.1 millimeter to about 1 millimeter or from about 100 nm to about 1000 nm.

Any such analysis in accordance with the present invention may be an isolated analysis, such as analysis of a static sample. Likewise, the analysis may be employed over time intervals for dynamic analysis. It should be understood that the intervals of time used for dynamic measurements may vary over a very large range and may be chosen depending on rate of change of the sample materials, the desired accuracy of the measurements of change over time or taking into account other factors. As such, the intervals of time are substantially limitless and may be chosen as needed or desired within the scope of the present invention.

In one exemplary embodiment, topographies are determined at several predetermined time intervals as a combinatorial library of sample material expands or contracts. In turn, the topographies may then be used to determine volumes of the sample materials with respect to time as a measure of the rate of expansion or contraction of the materials. Moreover, if the mass or weights of the sample materials are known or determinable, the volumes may be used to determine densities of the sample materials with respect to time. The sample materials may expand or contract due to various stimuli. Stimuli that might cause expansion, contraction or density change include environmental conditions such as heat, cold, pressure, humidity and the like. Other stimuli might include chemical reaction such as polymeric cross-linking and the like. Still other stimuli might include phase change of the sample material such evaporation processes, solidification, gas phase deposition, plasma vapor deposition and the like. It should be noted that, measurements for expansion or contraction of sample materials may be taken during such expansion or contraction or may be taken prior to and/or after contraction or expansion.

Dynamic or static measurements of topography or movement of sample materials of a combinatorial array may also be taken during motion of the sample materials due to forces placed upon the sample materials or after movement of the sample materials has been effected. Such forces may cause vibration, oscillation, expansion or contraction of the sample materials.

According to another embodiment, sample topography is measured in response to a dynamic stimulus applied to the sample. For example, one such stimulus might be an oscillation, and the sample may be monitored to determine frequency dependent characteristics of the sample or the combination of sample and substrate. In a preferred embodiment, samples are deposited upon a sample support that is capable of being oscillated or which has a compatible natural frequency. The sample is oscillated and data is obtained from the oscillating sample, either continuously (e.g., real-time) or at predetermined instances or intervals. Any suitable frequency may be employed. Preferably it is at least about 0.1 Hz, more preferably at least 100 Hz, and still more preferably at least 1000 Hz. Higher frequencies are also possible, for example at least about 100 kHz, more preferably at least about 100 MHz, and still more preferably at least about 1 GHz.

By way of illustration, referring to FIGS. 5(b)-5(c), the sample materials may be provided on a sample support of any of a variety of different configurations, typically characterized as having a suspended member. For example, in FIG. 5(b), there is illustrated a sample support 500 that has been formed into a cantilever configuration with a supported flexible end or portion 502 that is capable of oscillating. In FIG. 5(c), there is illustrated a sample material 510 that has been formed into a bridge configuration with a central supported portion 512 that is also capable of oscillating. The supported portions 502, 512 of the materials 500, 510 can be formed using any suitable art-disclosed technique, such as conventional patterning and etching techniques. In FIG. 5(d), an entire sample material 520 is supported by one or more upright members 524 wherein the sample material 520 includes at least a portion 522 of the sample material 520, if not the entire sample support 520, that is capable of oscillating.

For any of the sample supports 500, 510, 520 of FIGS. 5(b)-5(d), one or more forces may be applied to the materials 500, 510, 520 as indicated by the arrows 530 causing deformation of at least the portions 502, 512, 522 of the supports 500, 510, 520. Preferably, the forces 530 are applied with an appropriate probe that can be quickly moved away from the sample materials 500, 510, 520 such that the deformed portions 502, 512, 522 oscillate in response to the applied forces 530. Thereafter, topographic or distance measurements may be taken utilizing the above described methods. Preferably, the forces cause oscillation of the portions 502, 512, 522 of the materials 500, 510, 520 such that the AC (alternating current) resonance of the sample materials 500, 510, 520 may be determined by rapidly performing repeated measurements of the distance that portions 502, 512, 522 of the sample supports 500, 510, 520 are away from a measuring system such as the systems described above.

In FIGS. 5(e) and 5(f), there is illustrated a sample support 550 that has been originally positioned to have a cantilevered arm or end 552. Once properly positioned, the sample support 550 is heated until the cantilevered end 552 deforms (i.e., bends) due to the force of gravity as shown in FIG. 5(f). Thereafter, the sample support 550 is cooled until the cantilevered end 552 returns to its original position. As the cantilevered end 552 is deformed or as it returns to original position, topographic or distance measurements may be taken to monitor the movement of the end 552. The response of the samples will manifest itself in the measurable response of the sample support. Simultaneously, the temperature of the material 550 may also be monitored using a variety of techniques. Accordingly, the beginning of the bending of the end 552 or the returning of the end 552 to its original position may be associated with the temperature at which these events occur, the temperature, according to one embodiment, being the glass transition temperature (T_{g}) of the sample material 550.

FIG. 5(g) illustrates an overhead plan view of another form of support 560, wherein suspension arms 562 suspend a trampolene platform 564, that is capable of oscillation. Sample material can be deposited onto the trampolene platform.

Measuring responses of sample materials to forces can yield valuable information for many various materials. However, such measurements can be particularly valuable for certain kinds of materials. For instance, in the semiconductor industry, knowledge of AC resonance of various semiconductor materials such as silicon, silicon dioxide and the like can be particularly valuable. As another example, knowledge of glass transition temperatures of elastomers, polymers, plastics, plastomers and the like can be valuable in a wide field of industries.

While application of an AC resonance is one way to induce oscillation, other ways are possible as well including for example gas pulsation forces, capacitance forces, piezoelectric forces or other electromagnetic forces, thermoelectric forces, or the like. Further, it will be appreciated that the stimulus applied need not be oscillatory, but can be a single applied force, a plurality of different forces, or otherwise.

As will be gleaned from the above, the techniques described can be used to measure any changes to a sample material itself (e.g., its thickness, volume, surface contour or the like). It can also be employed to measure the effect that a sample material has upon another structure, such as a cantilever, a supported membrane or the like (either with or without an accompanying material volume change). Thus, sample properties that do not intrinsically result in a dimensional or displacement change can be measured via the effect of this change on the resonant or displacement properties of the composite structure (e.g., modulus change).

Sample-Throughput

For methods directed to characterizing a plurality of samples, a characteristic of each of the samples or of one or more components thereof is detected—serially or in a parallel, serial-parallel or hybrid parallel-serial manner—at an average sample throughput of not more than about 30 minutes per sample. As used in connection herewith, the term “average sample throughput” refers to the sample-number normalized total (cumulative) period of time required to detect a characteristic of two or more samples with a characterization system. The total, cumulative time period is delineated from the initiation of the characterization process for the first sample, to the detection of the last sample or of a component thereof, and includes any intervening between-sample pauses in the process. The sample throughput is more preferably not more than about 20 minutes per sample, even more preferably not more than about 10 minutes per sample and still more preferably not more than about 4 minutes per sample. Depending on the quality resolution of the characterizing information required, the average sample throughput can be not more than about 1 minute per sample, and if desired, not more than about 30 seconds per sample, not more than about 20 seconds per sample or not more than about 10 seconds per sample, and in some applications, not more than about 5 seconds per sample and not more than about 1 second per sample. Sample-throughput values of less than 4 minutes, less than 2 minutes, less than 1 minute, less than 30 seconds, less than 20 seconds and less than 10 seconds are demonstrated in the examples. The average sample-throughput preferably ranges from about 10 minutes per sample to about 10 seconds per sample, more preferably from about 8 minutes per sample to about 10 seconds per sample, even more preferably from about 4 minutes per sample to about 10 seconds per sample and, in some applications, most preferably from about 2 minutes per sample to about 10 seconds per sample.

Additionally, as shown in connection with the examples provided herein, the characterization of samples at such throughputs can offer sufficiently rigorous quality of data, to be useful for scientifically meaningful exploration of the material compositional and/or reaction conditions research space.

Hence, the average sample-throughput can range, in preferred cases, from about 10 minutes per sample to about 8 minutes per sample, from about 8 minutes per sample to about 2 minutes per sample, from about 2 minutes per sample to about 1 minute per sample, from about 1 minute per sample to about 30 seconds per sample and from about 1 minute per sample to about 10 seconds per sample, with preferences depending on the quality of resolution required in a particular case. For example, in some research strategies, the very high sample throughputs can be effectively employed to efficiently screen a sample or component thereof. In short, the search can be accelerated.

Calibration Methods and Standards

As desired the systems and methods of the present invention may optionally employ a calibration procedure. By way of example, a calibration standard is provided having a number of subcomponents that may differ with respect to a known characteristic of a material. Such subcomponents are typically referred to as “known standards” or, simply, “standards” that are well characterized with respect to the calibrating characteristics of interest. They are analyzed by the measuring apparatus of the present invention and the apparatus is adjusted as desired.

The accuracy and precision of the determination of material characteristics can vary depending on the type of measurement being conducted, the purpose of the measurements and the like. According to one embodiment the response, the stimulus or both applied to each of the material samples of the samples may be ranked or indexed and the ranked or indexed characteristics may be compared with each other. In such a case, accuracy and precision with regard to determining exact values of the characteristics of the sample materials may not be as important as assuring that the tests are performed consistently upon samples that are compared to each other since the object of the testing may be to determine which materials perform best rather than determining exact material characteristics. In other cases, such as when the stimuli and responses of the sample materials will be used to compare the sample materials to known characteristics of known materials, it may be more important to determine values for sample material characteristics such as density, expansion or the like that are closer to the absolute values of those characteristics for the sample materials to allow useful comparisons. The skilled artisan will recognize that the methods and apparatuses discussed above can be configured to be more or less accurate depending upon the equipment used and that the choice of equipment can depend on constraints such as monetary constraint and upon the amount of accuracy needed for a particular purpose.

Other Screens

The present invention may be employed by itself or in combination with other screening protocols for the analysis of liquids or their constituents. Without limitation, examples of such screening techniques include those addressed in commonly-owned U.S. Pat. No. 6,182,499 (McFarland et al); U.S. Pat. No. 6,175,409 B1 (Nielsen et al); U.S. Pat. No. 6,157,449 (Hajduk et al); U.S. Pat. No. 6,151,123 (Nielsen); U.S. Pat. No. 6,034,775 (McFarland et al); U.S. Pat. No. 5,959,297 (Weinberg et al), U.S. Pat. No. 5,776,359 (Schultz et al.), all of which are hereby expressly incorporated by reference herein.

Screening techniques may also include (without limitation) optical screening, infrared screening, mechanical property screening, electrochemical screening, flow characterization (e.g., gas, liquid or gel-phase chromatography), spectrometry, crystallography, or the like.

It is also possible that samples may be screened in accordance with the present invention while on the same substrate upon which it has been synthesized, filtered or otherwise processed. In this regard, the present invention may be used alone or in combination with systems for the synthesis or deposition of samples. For example, the instrumentation of the present invention may be included as part of a deposition apparatus, e.g., in an enclosed chamber, such as in connection with a chemical or physical deposition apparatus.

As can be seen, the present invention offers an attractive alternative approach to the rapid throughput analysis of surfaces of micro-scale samples, useful in the synthesis or screening of a plurality of the same or different samples. Though contact techniques are possible, the invention permits analysis of surface changes and measurements of distances without the need for, or substantially free of any contact between the analytical instrument or probe and the sample surface. As such the applications are virtually boundless. While it is expected that the present invention will be employed in connection with inorganic chemistry applications, the organic chemistry applications are also numerous, particularly in the field of polymer characterization. For instance the present invention is particularly attractive for measuring polymer swelling, viscoelastic response, and extent of cross-linking of respective samples in a library. Another useful application in the biological art would be for analyzing samples for determining whether a particular antigen binds with an antibody, whether DNA has been adsorbed, or the like.

Of course, the present invention is useful to efficiently measure or characterize any of a variety of materials, with particular emphasis on solid materials (including but not limited to densified, porous, particulated, fibrous, woven, unwoven, or the like), liquid materials, gels, adhesives, lubricants, coatings or the like. It may be used in connection with a research program for investigating metals, ceramics, polymers (biological or nonbiological, as well as oligomers), fine chemicals, pharmaceuticals, composites, or the like. It may be employed for examining organic or inorganic pigments, carbon powders (e.g., carbon black), metal compounds, metal oxides, metal salts, metal colloids, metal ligands, etc, without particular limitation. Other materials, which may be characterized according to the present invention include, without limitation, semiconducting, superconducting and conducting materials, luminescent materials, phosphorescent materials, amorphous materials, or the like.

It should be understood that the invention is not limited to the exact embodiment or construction which has been illustrated and described but that various changes may be made without departing from the spirit and the scope of the invention.

What is claimed is:

1. A method for optically screening sample materials for at least one characteristic, the method comprising:
(a) providing a library of at least four sample materials upon a substrate;
(b) directing an electromagnetic wavefront through a partial mirror at a surface of each of the at least four sample materials wherein the surface of each of the at least four sample materials is substantially non-planar;
(c) monitoring a response of the electromagnetic wavefront after the wavefront encounters the at least four sample materials; and
(d) correlating the response of the electromagnetic wavefront to a characteristic of the at least four sample materials;
wherein steps (a) through (d) are performed without substantially contacting the at least four sample materials with any probe.

2. A method as in claim 1 wherein the at least four sample material are provided upon a substrate with a flexible portion.

3. A method as in claim 1 wherein the characteristic of the at least four sample materials is topography of a surface of the at least four sample materials.

4. A method as in claim 3 further comprising correlating the topography of the surface of the at least four sample materials to a volume of the at least four sample material.

5. A method as in claim 4 wherein a mass of the at least four sample materials is predetermined and the method further comprises correlating the mass of the at least four sample materials and the volume of the at least four sample materials to a density of the at least four sample materials.

6. A method as in claim 1 wherein steps (b) through (d) are repeated for determining a change in the characteristic.

7. A method as in claims 1 and 6 wherein said characteristic is size of the at least four sample material

8. A method as in claim 6 wherein the characteristic is a volume of the at least four sample materials.

9. A method as in claim 6 wherein each of the at least four sample materials is supported upon a suspended platform.

10. A method as in claim 9 further comprising applying a stimulus to the at least four sample materials prior to the step of monitoring the response of the electromagnetic wavefront wherein the stimulus causes movement of the at least four sample materials at least during a portion of the step of monitoring the response of the electromagnetic wavefront.

11. A method as in claim 10 wherein the movement is at least partially oscillation.

12. A method as in claim 11 wherein the characteristic of the at least four sample materials is AC resonance.

13. A method as in claim 1 wherein said electromagnetic wavefront is provided by an interferometer.

14. A method as in claim 1 wherein the electromagnetic wavefront is provide by a laser.

15. A method as in claim 1 wherein the electromagnetic wavefront has a narrow bandwidth wavelength.

16. A method as in claim 1 wherein the electromagnetic wavefront is a single wavelength monotonic light.

17. A method for optically screening sample materials for topography, the method comprising:
(a) providing a library of at least four sample materials;
(b) directing an electromagnetic wavefront simultaneously at a surface of each of the at least four sample materials;
(c) monitoring a reflected portion of the electromatic wavefront that is reflected off of the at least for sample materials; and
(d) correlating the reflected portion of the electromagnetic wavefront to a topography of each of the at least four sample materials.

18. A method as in claim 17 wherein steps (a) through (d) are performed without contacting the at least four sample materials with a solid object.

19. A method as in claim 17 further comprising:
(e) correlating the topography of the surface of the at least four sample materials to a volume of the at least four sample material.

20. A method as in claim 19 wherein a mass of the at least four sample materials is predetermined and the method further comprises correlating the mass of the at least four sample materials and the volume of the at least four sample materials to a density of the at least four sample materials.

21. A method as in claim 17 wherein steps (b) through (d) are repeated for determining a change in the topography of the at least four sample materials.

22. A method as in claim 21 wherein each of the at least four sample materials is supported upon a suspended platform.

23. A method as in claim 22 further comprising applying a stimulus to the at least four sample materials prior to the step of monitoring the reflected portion of the electromagnetic wavefront wherein the stimulus causes movement of the at least four sample materials at least during a portion of the step of monitoring the reflected portion of the electromagnetic wavefront.

24. A method as in claim 23 wherein the movement is at least partially oscillation.

25. A method as in claim 24 wherein the characteristic of the at least four sample materials is AC resonance.

26. A method as in claim 17 wherein said electromagnetic wavefront is provided by an interferometer.

27. A method as in claim 17 wherein the electromagnetic wavefront is provide by a laser.

28. A method as in claim 17 wherein the electromagnetic wavefront has a narrow bandwidth wavelength.

29. A method as in claim 17 wherein the electromagnetic wavefront is a single wavelength monotonic light.

30. A method for optically screening an array of sample materials to determine density of the array of sample materials, comprising:
(a) providing a library of at least sixteen sample materials wherein each of the at least sixteen sample materials are supported by one or more substrates and wherein each of the at least sixteen sample materials is a polymeric product of a separate polymer synthesis reaction;
(b) directing an electromagnetic wavefront at each of the at least sixteen sample materials with a laser wherein the laser is at least a portion of an analytical system;
(c) monitoring the electromagnetic wavefront with a monitor of the analytical system after the wavefront is reflected from a surface of each of the at least sixteen sample materials to determine distances of the surface from a reference location for determining the topography of the surface as mathematical function;
(d) correlating the topography of the surface of the each of the at least sixteen sample materials to a volume of the at least sixteen sample materials by integrating the mathematical function over an area defined by the surface of each of the at least sixteen sample materials;
(e) repeating steps (b)-(d) to determine any change in the density of the at least sixteen sample materials.
